(19) United States
(12) Patent Application Publication
(10) Pub. No.: US 2013/0309340 A1
(43) Pub. Date: Nov. 21, 2013

(54) Lubrication Of Bearing And Roller Shaft In Pellet Mill Machines

(71) Applicant: Stephen E. Day, Phelps, NY (US)

(72) Inventor: Stephen E. Day, Phelps, NY (US)

(21) Appl. No.: 13/472,869

(22) Filed: May 16, 2012

(51) Int. Cl. B29C 47/94; F16N 39/02; F16N 39/06; F16N 7/40

(52) U.S. Cl. 425/107; 184/6; 184/6.22; 184/6.24

(57) ABSTRACT

A system for recirculating lubricant to cool and lubricate a pellet mill including: a die; first and second roller assemblies received by the die; and a main shaft in communication with the roller assemblies, a pump, and a reservoir. The system provides fluid to a cavity formed between an inner surface of the plurality of bearings, an inner surface of the roller shell, a liner and a seal on each end of the roller shaft of each of the roller assemblies. Fluid fills the cavity through a first passage of the roller shaft of the roller assembly until fluid can enter a second passage of the roller shaft of the roller assembly. From the second passage, fluid may flow out of the roller shaft and roller assembly to another roller assembly or back to the main shaft.

### BACKGROUND OF THE INVENTION

1. Field of the Invention

The invention pertains to the field of pellet mill machines. More particularly, the invention pertains to lubrication and cooling of bearings and roller shafts in pellet mill machines.

2. Description of Related Art

Pellets are used for different purposes, for example for fuel, animal bedding or for animal feed. Pellets are comprised of a compressed raw material. The raw material is a biomaterial, which may be for example dried feed components, wood, sawdust or other wastes from sawmilling and other wood products manufacture.

FIGS. 1-2 show a conventional roller shaft with a single grease outlet. Typically, the roller shaft 2 is surrounded by a bearing, which is received by a roller shell. The roller shaft 2 has a single passage 4 that runs approximately half the length of the roller shaft 2 with an inlet 6 and an outlet 8.

When the roller shaft 2 is manually greased or greased automatically, grease enters the passage 4 of the roller shaft through the inlet 6 and travels through the passage and out the outlet 8 to an outside surface 9 of the roller shaft 2, which is surrounded by at least one bearing, and to a surface between the bearing and the roller shell.

To manufacture pellets, raw biomaterial is fed into a pellet mill to a pelleting chamber formed between a die, a main shaft and a pair of roller assemblies. Each roller assembly includes a roller shaft 2 surrounded by bearings, which are received within a roller shell. The outer surface of the roller shell compacts the raw biomaterial into the holes of the die as the die rotates and causes the roller shells of the roller assemblies to rotate through the bearings on the fixed roller shafts 2. As the raw biomaterial is extruded through the holes of the die, the biomaterial is heated, melting the biomaterial and allowing the biomaterial to be formed as a pellet. Knives cut the pellets as they are extruded from the die.

During the pelleting process, the roller assemblies are subject to high temperatures. The bearings of the roller assemblies need to be replaced often due to warping resulting from high heat used during the pelleting process. Currently, bearings need to be replaced after 80 to 250 hours of operating time. The number of hours is based on the material being used to make the pellets.

To compensate for the high temperatures of the pelleting process, the prior art roller shaft 2 has a single grease exit hole 8 along its shaft 2 and a user has to grease the roller shaft 2 manually approximately every fifteen minutes during operation. The grease lubricates the bearings, but does not cool the bearing or dissipate the heat from the bearing. The grease that exits the roller assemblies can be in excess of 500° F. Furthermore, having to manually grease the machine every fifteen minutes is tedious and labor intensive for a user.

While an automated greater may be used to continuously grease the shaft 2 within the roller shell, the grease can enter the pellets being made. This is unacceptable for some uses of the pellets (for example pellets used as animal bedding and animal feed) and the grease that is continually pumped into the shaft 2 is good for only one use, which can become very expensive for the user. Furthermore, the automated greasing does not remove any of the intense heat that can warp the bearings.

In some conventional pellet mill machines, temperature sensors are present within the roller shafts, and if the temperature within the roller shafts reaches a specific temperature which can damage the bearings, the machine will shutdown in order to cool and attempt to preserve the bearings, limiting production of pellets.

### SUMMARY OF THE INVENTION

A system and method for recirculating lubricant to cool and lubricate a pellet mill machine comprising: a die; a main shaft received by die comprising a first passage and a second passage extending a length, the first passage in fluid communication with a pump and the second passage in fluid communication with a reservoir; and at least a first roller assembly and a second roller assembly received within the die.

Each roller assembly includes a roller shaft; a plurality of bearings mounted on the outer surface of the roller shaft, forming a cavity between an inner surface of the plurality of bearings, a liner and a seal; and a roller shell surrounding the plurality of bearings and the roller shaft. The roller shell is rotatable relative to the roller shaft and the die.

Each roller shaft of a roller assembly has a first passage for receiving lubricant, extending a length of the roller shaft and outputting lubricant through a first hole to an outer surface of the roller shaft; a second passage for receiving lubricant parallel to the first passage, extending a length of the roller shaft and outputting lubricant through a second hole to an outer surface of the roller shaft. The first hole is preferably spaced at least 90 degrees apart from the second hole along the outer surface of the roller shaft.

The first passage of the main shaft is in fluid communication with the first passage of the first roller assembly through a first line and the second passage of the main shaft is fluid communication with the second passage of the second roller assembly through a second line. The second passage of the first roller assembly is in fluid communication with the first line of the second roller assembly through a third line.

During operation, lubricant flows from the pump to the first passage of the main shaft, through the first line to the first passage of the roller shaft of the first roller assembly, and out of the first passage through the first hole to the outer surface of the roller shaft. The lubricant exiting the first hole lubricates and bathes the inner surfaces of the plurality of bearings surrounding the roller shaft of the first roller assembly, fills the cavity, and enters the second hole of the second passage of the roller shaft of the first roller assembly.

Lubricant from the second hole flows into the second passage of the roller shaft of the first roller assembly, through the third line to the first passage of the roller shaft of the second roller assembly, and out of the first passage through the first hole to the outer surface of the roller shaft of the second roller assembly. The lubricant exiting the first hole lubricates and bathes the inner surfaces of the plurality of bearings surrounding the roller shaft of the second roller assembly, fills the cavity and enters the second hole of the second passage of the roller shaft of the second roller assembly and flows through the second line to the second passage of the main shaft and to the reservoir.

### BRIEF DESCRIPTION OF THE DRAWINGS

FIG. 1 shows a side view of a conventional roller shaft of a pellet mill machine.

FIG. 2 shows a front view of a conventional roller shaft of a pellet mill machine.

FIG. 3 shows an exploded view of the roller assembly of an embodiment of the present invention.

FIG. 4 shows a side view of a shaft of an embodiment of the present invention.

FIG. 5 shows a front view of a shaft of an embodiment of the present invention.

FIG. 6 shows a schematic view of the recirculating oil flow path through the roller assemblies of a pellet mill machine.

FIG. 7 shows an exploded view of the roller assemblies of the present invention relative to the die of the pellet mill machine.

### DETAILED DESCRIPTION OF THE INVENTION

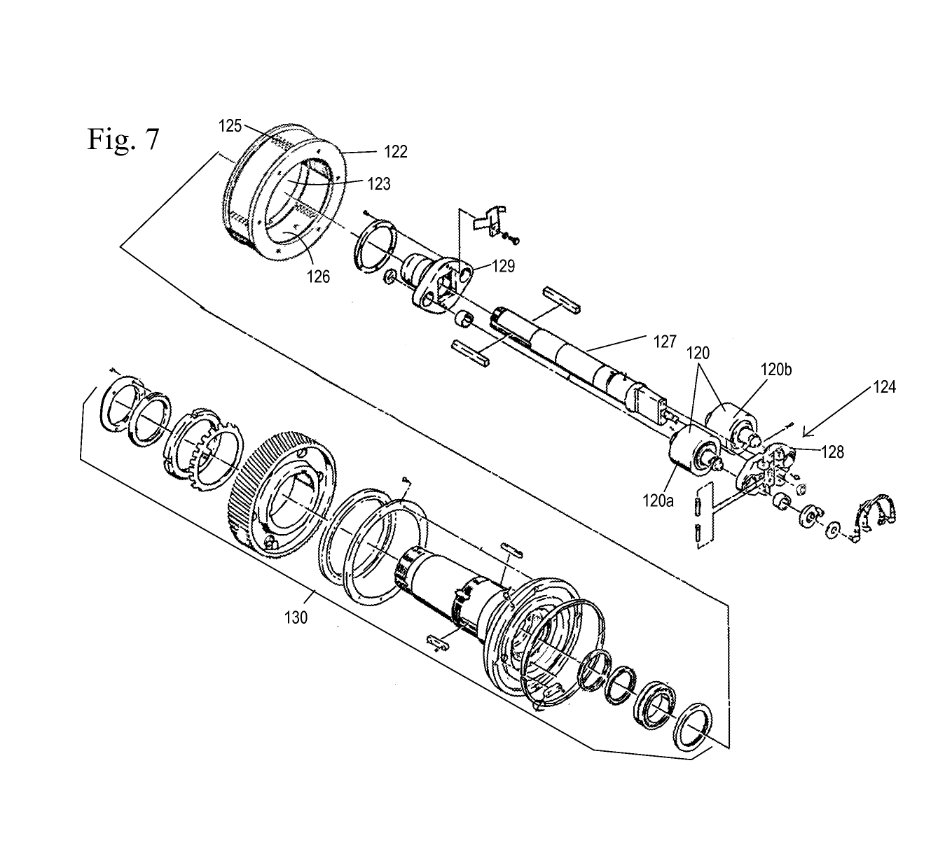

FIG. 7 shows an exploded view of roller assemblies 120a, 120b in an embodiment of the present invention relative to the die 122 and the main shaft 127 of the pellet mill machine. A die 122 defines a cavity 123 in which at least a pair of roller assemblies 120a, 120b which are mounted on a carriage 124 that has a front support 128 and a back support 129. Also mounted to the carriage 124 is the main shaft 127. The main shaft 127 is rotated by a quill drive assembly 130. The die 122 has a plurality of openings 125 circumferentially and axially spaced for receiving biomaterial from within the cavity 123 compressed between the roller assemblies 120a, 120b and an interior surface 126 of the die 122. Upon relative rotation of the die 122 and the roller assemblies 120a, 120b, biomaterial is extruded through the openings 125 and forms pellets along the outside of the die 122 which are removed by blades (not shown) along the outside of the die 122.

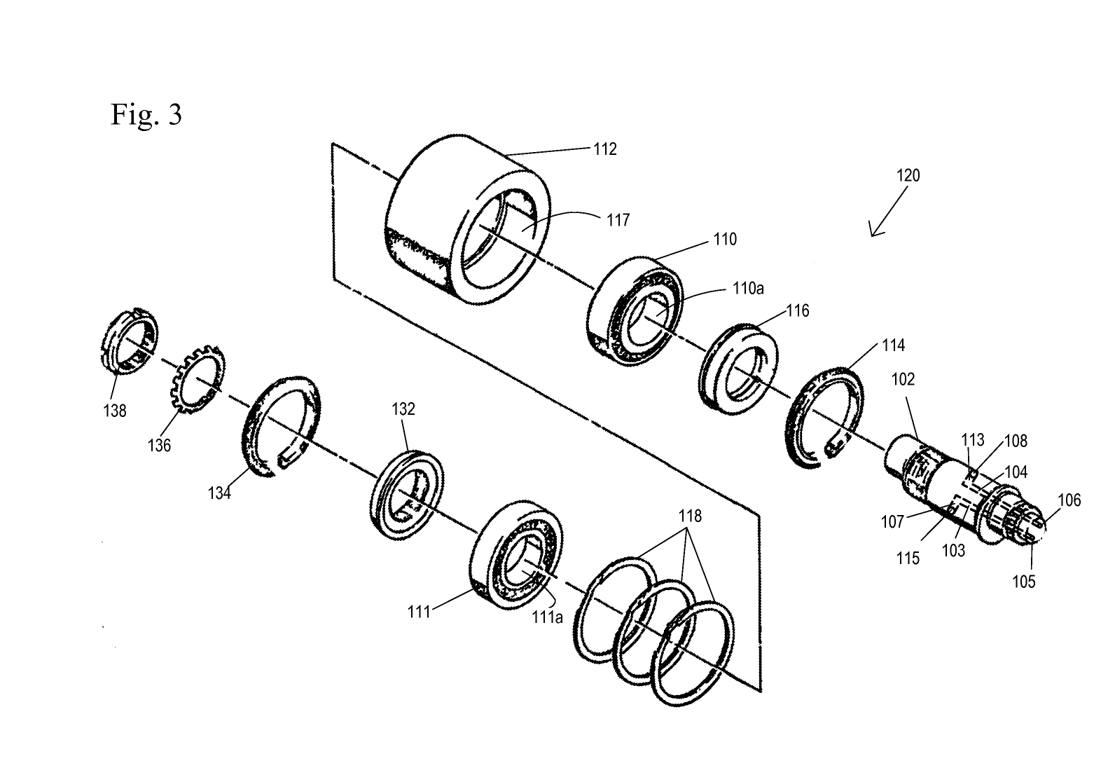

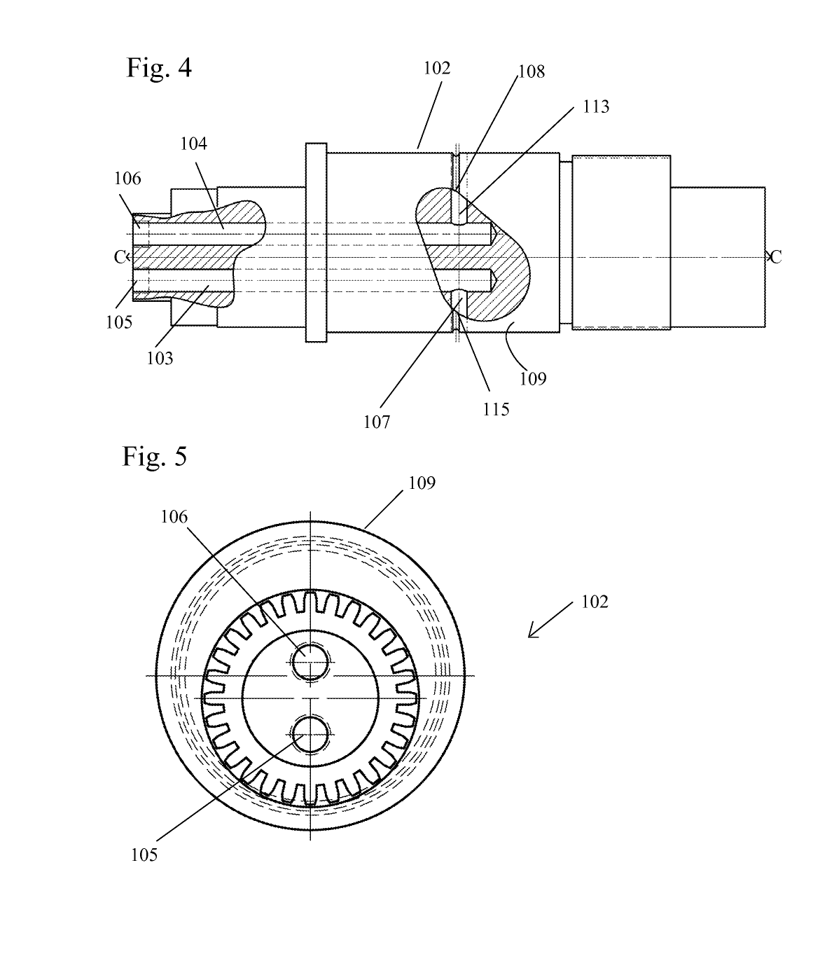

FIGS. 3-5 shows a roller shaft assembly 120 in an embodiment of the present invention. The roller assembly 120 includes a roller shaft 102, a plurality of bearings 110, 111 mounted on an outer circumferential surface 109 of the roller shaft 102, and roller shell 112 surrounding the bearings 110, 111 and the roller shaft 102.

The roller shaft 102 includes two parallel passages 103, 104 of a length approximately equal to half the length of the roller shaft 102, although slightly longer or slightly shorter passages may also be used along an axis parallel to the axis C-C of the roller shaft 102. Each of the passages 103, 104 are formed by closed end bores, with the open ends 105, 106 of the passages 103, 104 in fluid communication with a main shaft 127.

Passage 103 is connected to the outer surface 109 through opening 115 of the roller shaft through a passage 107 perpendicular to the axis of the C-C of the roller shaft 102 and the passage 103. Passage 104 is connected to the an outer surface 109 through opening 108 of the roller shaft through a passage 113 perpendicular to the axis of the C-C of the roller shaft 102 and the passage 104.

The stationary roller shaft 102 is received by a front bearing 110 maintained in place on the roller shaft 102 through a collar 116 and seal 114 and a back bearing 111 through retaining rings 118, which maintain the spacing of the front bearing 110 relative to the back bearing 111 on the roller shaft 102. The bearings 110, 111 and the roller shaft 102 are held within a groove 117 of the roller shell 112 by locking the bearings 110, 111 into place relative to the roller shell 112 though a lock nut 138 which engages a lock washer 136, which is adjacent a seal 134 and bears against a lock nut liner 132 adjacent the back bearing 111. The pellet machine preferably has two roller assemblies 120a, 120b, which are received within a cavity 123 formed by a die 122 as shown in FIG. 7.

The collar 116 and the lock nut liner 132 may be coated with a sealant to prevent leakage of lubricant from the roller assembly 120.

Lubricant flows from the main shaft 127, through open end 105 to passage 103. From passage 103, lubricant flows through passage 107 and out hole 115, lubricating the inner surface 110a, 111a of the bearings 110, 111, and a seal 114 and lock nut liner 132. Once the lubricant reaches hole 108, lubricant flows into passage 113, through passage 104 and through open end 106, allowing lubricant to recirculate between passages 103 and 104, the main shaft 127 and the other roller assembly, ensuring a constant flow of lubricant to the inner surfaces 110a, 111a of the bearings 110, 111 on each of the roller shafts. As the lubricant recirculates, the inner surfaces 110a, 111a of the bearings 110a, 111 are bathed with lubricant and cooled.

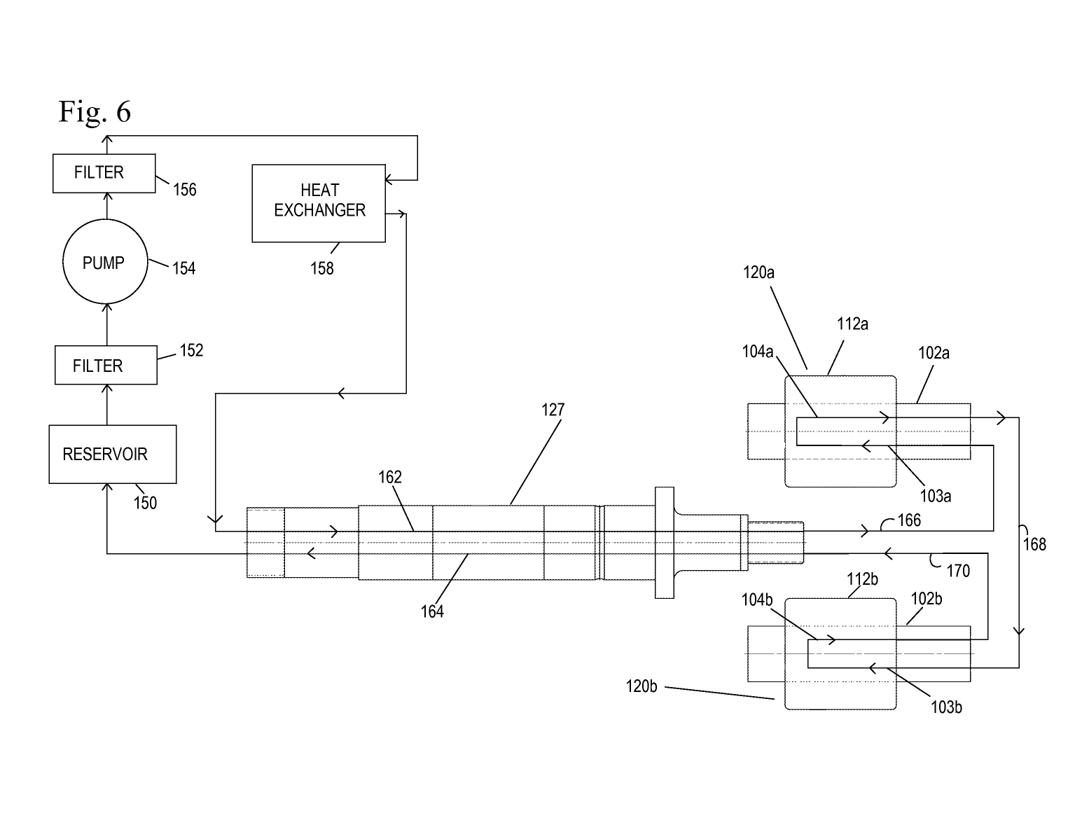

FIG. 6 shows the flow of lubricant recirculating through the roller assemblies 120a, 120b and the main shaft 127 of the pellet mill machine. The main shaft 127 has two parallel passages 162, 164 extending the entire length of the main shaft 127 along an axis parallel to a central axis C-C of the main shaft 127. The first passage 162 is in fluid communication with a heat exchanger 158 at one end and a first passage 103a of a first roller assembly 120a through a line 166. The second passage 164 of the main shaft 127 is in fluid communication a reservoir 150 at one end and a second line 104b of the second roller assembly 120b through line 170. A second line 104a of the first roller assembly 120a is connected to the first line 103b of the second roller assembly 120b through line 168.

During operation of the pellet mill machine, pump 154 pumps lubricant through a filter 156 to a heat exchanger 158. From the heat exchanger 158, lubricant flows to the first passage 162 of the main shaft 127 and flows out through line 166 to the first passage 103a of a first roller assembly 120a.

From the first passage 103a of the first roller assembly 120a, lubricant flows to passage 107 and out hole 115 to the outer surface 109 of the roller shaft 102a, filling a cavity between an inner surface 110a, 111a of the bearings 110, 111, collar 116 with seal 114, lock nut liner 132 with seal 134 and an inner surface of roller shell 112, lubricating the inner surface 110a, 111a of the bearings 110, 111. Once the lubricant fills the cavity to a point in which lubricant enters hole 108, lubricant recirculates to passage 113, to the second passage 104a and out of the first roller assembly 120a.

From the first roller assembly 120a, lubricant flows through line 168 to the first line 103b of the second roller assembly 120b. From the first line 103b of the second roller assembly 120b, fluid flows to passage 107 and out hole 115 to the outer surface 109 of the roller shaft 102b, filling a cavity between an inner surface 110a, 111a of the bearings 110, 111, collar 116 with seal 114, lock nut liner 132 with seal 134 and an inner surface of the roller shell 112, lubricating the inner surfaces 110a, 111a of the bearings 110, 111. Once the lubricant fills the cavity to a point in which lubricant enters hole 108, lubricant recirculates to passage 113, to the second passage 104a and out of the second roller assembly 120b to the second passage 164 of the main shaft through line 170.

The used lubricant then flows from the second passage 164 of the main shaft 127 to a reservoir 150. From the reservoir 150, the lubricant is filtered 152 and sent to the pump 154.

In an alternative embodiment, the heat exchanger is not present and the filtered lubricant is sent directly to the first passage 162 of the main shaft 127.

In one embodiment, the reservoir 150, filters 152, 156, pump 154 and the heat exchanger 158 may be located outside of the pellet mill machine. In an alternative embodiment, the reservoir 150, filters 152, 156, pump 154 and the heat exchanger 158 may be part of the pellet machine. For example, the pump 154 may be the pump present in a gearbox of the pellet mill machine.

By recirculating the lubricant, the bearings 110, 111 of the roller assemblies 120a, 120b are bathed in lubricated and cooled without exposing the biomaterial used to make pellets to the lubricant.

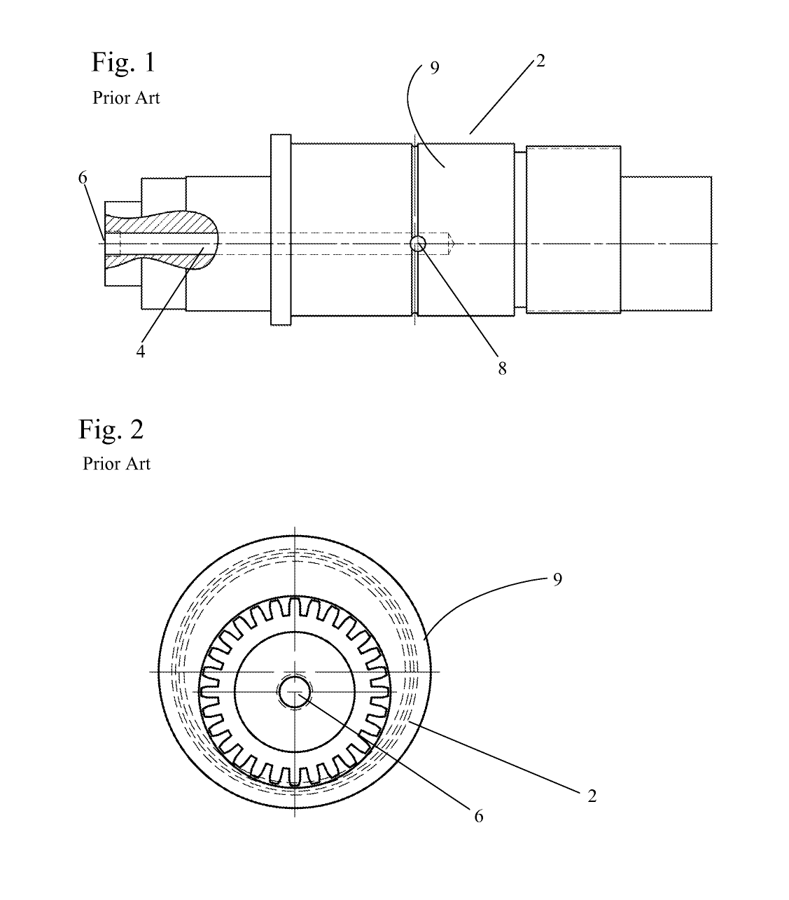

Since the lubricant is filtered after recirculating through and bathing the roller assemblies 120a, 120b, the lubricant may be reused, saving the user of the pellet mill machine the cost of using the lubricant one time only as in the automated greasing or manually greasing of the prior art. Furthermore, by having the lubricant recirculate and bathe the bearings, the temperature of the lubricant after it has circulated through the roller assemblies 120a, 120b is significantly lower, decreasing warping and wear of the bearings 110, 111. For example, the oil exiting the roller assembly of the present invention is approximately 125° F. in comparison to approximately 300-450° F. in conventional, prior art designs as shown in FIGS. 1-2.

Also, the bearings of the present invention last in excess of 300 hours of operation before having to be replaced. Decreasing the time spent having to change the bearings, which involves cooling the machine down and changing the bearings, costing a user at least one full day of production every 80 to 250 hours of production.

Furthermore, by recirculating and bathing the roller assemblies 120a, 120b with lubricant, the bearings do not reach very high temperatures, enabling the production to be maintained and due to the low temperatures that are present, production may be increased approximately a quarter ton an hour. The rate of production of pellets of a pellet mill machine of the present invention is approximately half a ton an hour and the bearings have been used in excess of 300 hours without having to replace the bearings, in comparison to 120 hours of production before having to replace the bearings.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for recirculating lubricant to cool and lubricate a pellet mill machine comprising:
a) a die defining a cavity having a series of circumferentially and axially spaced openings;
b) a main shaft received by the cavity of the die comprising a first passage and a second passage extending a length of the main shaft, the first passage in fluid communication with a pump and the second passage in fluid communication with a reservoir;
c) at least a first roller assembly and a second roller assembly received within the cavity of the die, each roller assembly comprising:
i) a roller shaft comprising:
A) a first passage for receiving lubricant, extending a length of the roller shaft, and outputting lubricant through a first hole to an outer surface of the roller shaft; and
B) a second passage for receiving lubricant, parallel to the first passage, extending a length of the roller shaft, and outputting lubricant through a second hole to an outer surface of the roller shaft;
ii) a plurality of bearings mounted on the outer surface of the roller shaft;
iii) a roller shell surrounding the plurality of bearings and the roller shaft, wherein the roller shell is rotatable relative to the roller shaft and the die;
iv) a cavity formed between an inner surface of the plurality of bearings, an inner surface of the roller shell, a liner and a seal on each end of the roller shaft;
wherein the first passage of the main shaft is in fluid communication with the first passage of the first roller assembly through a first line and the second passage of the main shaft is fluid communication with the second passage of the second roller assembly through a second line;
wherein the second passage of the first roller assembly is in fluid communication with the first line of the second roller assembly through a third line; and
wherein lubricant flows from the pump to the first passage of the main shaft, through the first line to the first passage of the roller shaft of the first roller assembly, and out of the first passage through the first hole to the outer surface of the roller shaft, such that lubricant bathes the inner surface of the plurality of bearings surrounding the roller shaft of the first roller assembly, fills the cavity, and enters the second hole of the second passage of the roller shaft of the first roller assembly; and
wherein lubricant from the second hole flows into the second passage of the roller shaft of the first roller assembly, through the third line to the first passage of the roller shaft of the second roller assembly, and out of the first passage through the first hole to the outer surface of the roller shaft of the second roller assembly, such that lubricant bathes the inner surface of the plurality of bearings surrounding the roller shaft of the second roller assembly, fills the cavity, and enters the second hole of the second passage of the roller shaft of the second roller assembly and flows through the second line to the second passage of the main shaft and to the reservoir.

2. The system of claim 1, further comprising a heat exchanger between the pump and the first passage of the main shaft.

3. The system of claim 1, further comprising a filter between the reservoir and the pump.

4. The system of claim 1, wherein the pump is located within a gearbox of the pellet mill machine.

5. A method of recirculating lubricant between a first roller assembly, a second roller assembly and a main shaft in fluid communication with a reservoir and a pump, each roller assembly comprising: a roller shaft having a first passage for receiving lubricant, extending a length of the roller shaft, and outputting lubricant through a first hole to an outer surface of the roller shaft; and a second passage for receiving lubricant, parallel to the first passage, extending a length of the roller shaft, and outputting lubricant through a second hole to an outer surface of the roller shaft; a plurality of bearings mounted on an outer surface of the roller shaft; a roller shell surrounding the plurality of bearings and the roller shaft, wherein the roller shell is rotatable relative to the roller shaft and a die; and a cavity formed between an inner surface of the plurality of bearings, an inner surface of the roller shell, a liner and a seal on each end of the roller shaft, the method comprising the steps of:
a) pumping lubricant from the pump to a first passage of the main shaft in fluid communication with the first passage of the roller shaft of the first roller assembly through a first line;
b) bathing an inner surface of the plurality of bearings surrounding the roller shaft of the first roller assembly with lubricant by fluid flow from the first hole connected to the first passage of the first roller assembly;
c) filling the cavity with lubricant, until lubricant enters the second hole of the second passage of the roller shaft of the first roller assembly;
d) recirculating fluid from the second passage of the roller shaft of the first roller assembly to the first passage of the roller shaft of the second roller assembly through a third line;
e) bathing an inner surface of the plurality of bearings surrounding the roller shaft of the second roller assembly with lubricant by fluid flow from the first hole connected to the first passage of the second roller assembly;
f) filling the cavity with lubricant, until lubricant enters the second hole of the second passage of the roller shaft of the second roller assembly; and
g) recirculating fluid from the second passage of the roller shaft of the second roller assembly to a second passage of the main shaft in fluid communication with a reservoir.

6. The method of claim 5, further comprising a heat exchanger between the pump and the first passage of the main shaft.

7. The method of claim 5, further comprising a filter between the reservoir and the pump.

8. A roller shaft for a pellet mill machine comprising:
a first passage for receiving lubricant, extending a length of the roller shaft, and outputting lubricant through a first hole to an outer surface of the roller shaft; and
a second passage for receiving lubricant, parallel to the first passage, extending a length of the roller shaft, and outputting lubricant through a second hole to an outer surface of the roller shaft.

9. The shaft of claim 8, wherein the first passage and the second passage are open ended bores.
